(19) United States
(12) Patent Application Publication
(10) Pub. No.: US 2011/0248936 A1
(43) Pub. Date: Oct. 13, 2011

(54) TOUCH SCREEN-INTEGRATED LIQUID CRYSTAL DISPLAY

(75) Inventors: Sang Hwa KIM, Gyunggi-do (KR); Yong Soo OH, Gyunggi-do (KR); Jong Young LEE, Gyunggi-do (KR); Yong Hyun JIN, Seoul (KR)

(73) Assignee: SAMSUNG ELECTRO-MECHANICS CO., LTD., Gyunggi-do (KR)

(21) Appl. No.: 12/833,572

(22) Filed: Jul. 9, 2010

(30) Foreign Application Priority Data
Apr. 8, 2010 (KR) 10-2010-0032452

(51) Int. Cl. G06F 3/041

(52) U.S. Cl. 345/173

(57) ABSTRACT

Disclosed herein is a touch screen-integrated liquid crystal display, including: a backlight unit emitting light; a first polarizing plate disposed on the backlight unit; a liquid crystal panel disposed on the first polarizing plate and creating an image using the light emitted from the backlight unit; a touch screen disposed on the liquid crystal panel; a cholesteric liquid crystal plate disposed on the touch screen; a phase difference plate disposed on the cholesteric liquid crystal plate; and a second polarizing plate disposed on the phase difference plate.

### CROSS REFERENCE TO RELATED APPLICATION

This application claims the benefit of Korean Patent Application No. 10-2010-0032452, filed Apr. 8, 2010, entitled “Liquid crystal display having the touch screen”, which is hereby incorporated by reference in its entirety into this application.

### BACKGROUND OF THE INVENTION

1. Technical Field

The present invention relates to a touch screen-integrated liquid crystal display.

2. Description of the Related Art

Along with the advancement of information society, various types of displays are increasingly required. Recently, in order to meet this requirement, various types of flat panel displays, such as liquid crystal displays (LCDs), plasma display panels (PDPs), electroluminescent displays (ELDs) and the like, have been researched, and, currently, are being widely used.

Among the various types of flat panel displays, liquid crystal displays (LCDs) are currently replacing cathode ray tubes (CRTs) because they are advantageous in that they have high image quality, are light and thin, and require low power consumption. Further, liquid crystal displays (LCDs) are widely used to manufacture notebook monitors, televisions, etc.

Recently, touch screen-mounted liquid crystal displays (LCDs) have been developed. The touching of a touch screen by a user can cause such liquid crystal displays (LCDs) to select and display desired information. As the touch screen mounted in the liquid crystal display (LCD), a resistive touch screen or capacitive touch screen is chiefly being used.

Conventionally, methods for mounting a touch screen onto a liquid crystal display using an adhesive film have been chiefly used. However, these methods have been problematic in that the thickness of the liquid crystal display is increased and the transmissivity thereof is decreased.

Therefore, recently, liquid crystal displays integrated with a touch screen have been researched and commercially used.

Such touch screen-integrated liquid crystal displays have many advantages in the optical, physical and economical aspects, but have many problems to overcome, too.

In conventional touch screen-integrated liquid crystal displays, since a polarizing plate is disposed at the uppermost portion thereof, light emitted from a backlight unit disposed at the lower portion passes through a touch screen, thus decreasing transmissivity. In particular, in the case of a resistive touch screen, since an air layer is disposed between an upper electrode layer and a lower electrode layer, such a phenomenon becomes serious.

Therefore, when light emitted from the backlight is finally transferred to a user through an upper polarizing plate, the light transmission rate of the liquid crystal display is less than 50%. For this reason, in order to compensate the liquid crystal display for its low light transmission rate, the intensity of the luminescence of the backlight unit must be increased, with the result that there arises another problem of the power consumption being increased. Further, since mobile electronic appliances are directly influenced by the increase in power consumption, the above problem becomes all the more serious.

### SUMMARY OF THE INVENTION

Accordingly, the present invention has been made to solve the above-mentioned problems, and the present invention provides a touch screen-integrated liquid crystal display which includes a cholesteric liquid crystal plate and a phase difference plate in order to minimize the reduction of transmissivity when light emitted from a backlight unit passes through a polarizing plate and a touch screen.

An aspect of the present invention provides a touch screen-integrated liquid crystal display, including: a backlight unit emitting light; a first polarizing plate disposed on the backlight unit; a liquid crystal panel disposed on the first polarizing plate and creating an image using the light emitted from the backlight unit; a touch screen disposed on the liquid crystal panel; a cholesteric liquid crystal plate disposed on the touch screen; a phase difference plate disposed on the cholesteric liquid crystal plate; and a second polarizing plate disposed on the phase difference plate.

The touch screen-integrated liquid crystal display may further include: a diffusion sheet disposed between the liquid crystal panel and the touch screen.

Further, the touch screen-integrated liquid crystal display may further include: a protective film disposed on the second polarizing plate.

In the touch screen-integrated liquid crystal display, the upper substrate of the liquid crystal panel and the lower substrate of the touch screen may be formed into one substrate.

Further, the cholesteric liquid crystal plate may be formed by coating cholesteric liquid crystal between the upper substrate of the touch screen and the phase difference plate.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a touch screen-integrated liquid crystal display according to an embodiment of the present invention;

FIG. 2 is an exploded sectional view explaining the operational principle of the touch screen-integrated liquid crystal display shown in FIG. 1; and

FIGS. 3 to 6 are sectional views showing touch screen-integrated liquid crystal displays according to other embodiments of the present invention.

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

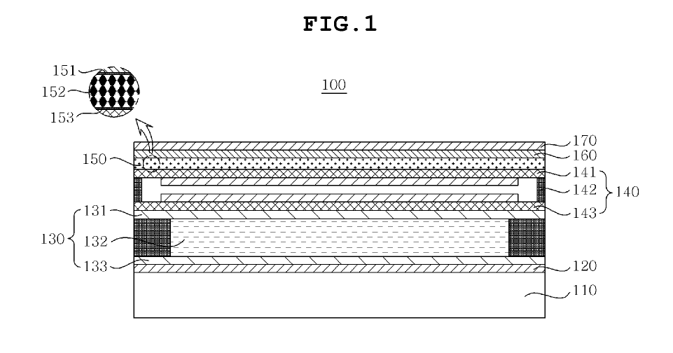

FIG. 1 is a sectional view of a touch screen-integrated liquid crystal display according to an embodiment of the present invention. Hereinafter, the touch screen-integrated liquid crystal display (hereinafter, referred to as “liquid crystal display”) according to this embodiment will be described in detail with reference to FIG. 1.

As shown in FIG. 1, the liquid crystal display 100 includes a backlight unit 110, a first polarizing plate 120, a liquid crystal panel 130, a touch screen 140, a cholesteric liquid crystal plate 150, a phase difference plate 160, and a second polarizing plate 170.

The backlight unit 110 serves to emit light and supply the emitted light to the liquid crystal panel 130, and includes a lamp, a reflecting plate covering the lamp, and a light guide plate.

The first polarizing plate 120 is disposed on the backlight unit 110, and serves to select a first polarized light having a predetermined orientation from the light emitted from the backlight unit 110 and supply the first polarized light to the liquid crystal panel 130.

The liquid crystal panel 130 is disposed on the first polarizing plate 120, and serves to create an image using the light emitted from the backlight unit 110. This liquid crystal panel 130 includes: an upper substrate 131 provided with a transparent common electrode; and a lower substrate 133 provided with an array wiring including a pixel region, a pixel electrode formed on the pixel region and a switching device. Here, liquid crystal 132 is charged between the upper substrate 131 and the lower substrate 133. The liquid crystal panel 130 may further include a color filter substrate (not shown).

The touch screen 140 is disposed on the liquid crystal panel 130. As the touch screen 140, a resistive touch screen or a capacitive touch screen may be employed.

The touch screen 140, which is an example of a resistive touch screen, includes: an upper substrate 141 whose lower surface is patterned with an upper transparent electrode film having uniform thickness and made of indium tin oxide (ITO), tin oxide (SnO₂), indium oxide (In₂O₃), a conductive polymer or the like and whose upper surface is printed in an X direction with an upper electrode wiring made of metal (for example, silver or copper) such that the upper electrode wiring electrically communicates with the upper transparent electrode film; a lower substrate 143 whose lower surface is patterned with a lower transparent electrode film having uniform thickness and made of indium tin oxide (ITO), tin oxide (SnO₂), indium oxide (In₂O₃), a conductive polymer or the like and whose upper surface is printed in a Y direction with a lower electrode wiring made of a metal (for example, silver or copper); and a spacer 142

Meanwhile, a digital resistive touch screen is configured such that each of upper and lower transparent electrode films is composed of a plurality of electrode film segments which are separated from each other. For example, each of upper and lower transparent electrode films may be composed of a plurality of bar-shaped electrode film segments which are arranged to be separated from each other.

Further, a capacitive touch screen is also configured such that a plurality of transparent electrode patterns are formed on upper and lower substrates in X and Y directions. However, the capacitive touch screen is configured such that upper and lower substrates do not come into contact with each other and such that transparent electrode patterns formed in an X direction are separated from transparent electrode patterns formed in a Y direction by a transparent insulation layer.

Meanwhile, the resistive touch screen chiefly employs a film substrate made of polyethylene terephthalate (PET), polyethylene naphthalene dicarboxylate (PEN), polycarbonate (PC), polyether sulfone (PES), polyimide (PI), cyclic olefin copolymers (COC), polystyrene, polyethylene, polypropylene, or the like. The capacitive touch screen generally employs a glass substrate.

Further, the conductive polymer for forming electrode films or electrode patterns includes at least one selected from polythiophene, polyacetal, polypyrrole, polyaniline, polyphenylenevinylene, polyparaphenylene and polyisothionaphthene, and, preferably, may be polythiophene.

The cholesteric liquid crystal plate 150 is disposed on the touch screen 140, and serves to pass a part of the light that has passed through the touch screen 140 and to reflect the other part thereof. This cholesteric liquid crystal plate 150 has a structure in which cholesteric liquid crystal 152 is charged between an upper film substrate 151 and a lower film substrate 153.

The cholesteric liquid crystal plate 150 is fabricated by coating the lower film substrate 153 with the cholesteric liquid crystal using spin coating, bar coating, spray coating, ink-jet printing, spreading or dipping and then forming the upper film substrate 151 thereon. Concretely, the cholesteric liquid crystal plate 150 is fabricated by applying the cholesteric liquid crystal 152 on the lower film substrate 153 and then polymerizing the cholesteric liquid crystal 152 using UV-irradiation. In this case, the UV-irradiation is conducted at a UV intensity of 0.1˜10 mW/cm² for 1˜10 minutes, preferably, 0.8 mW/cm² for 2˜5 minutes. The thickness of the cholesteric liquid crystal layer is 2˜10 μm.

The cholesteric liquid crystal plate 150 has a spiral liquid crystal orientation vector. When the spiral liquid crystal orientation vector is twisted right, the cholesteric liquid crystal plate 150 reflects right circular polarized light and allows left circular polarized light to pass. In contrast, when the spiral liquid crystal orientation vector is twisted left, the cholesteric liquid crystal plate 150 reflects left circular polarized light and allows right circular polarized light to pass. That is, incident light is reflected when its polarizing direction corresponds with the spiral direction and its wavelength meets the conditions for Bragg reflection.

The phase difference plate 160 is disposed on the cholesteric liquid crystal plate 150, and serves to convert the circular polarized light having passed through the cholesteric liquid crystal plate 150 into linear polarized light. This phase difference plate 160 may be disposed such that it is adjacent to the cholesteric liquid crystal plate 150 or it is spaced apart from the cholesteric liquid crystal plate 150. A quarter-wave plate may be used as the phase difference plate 160.

The second polarizing plate 170 is disposed on the phase difference plate 160, and serves to transfer the image created from the liquid crystal panel 130 to users.

This second polarizing plate 170 may be parallel to or perpendicular to the first polarizing plate 120 in a polarizing direction. The polarizing direction of the second polarizing plate 170 may be changed depending on whether the liquid crystal panel is normal white or normal black.

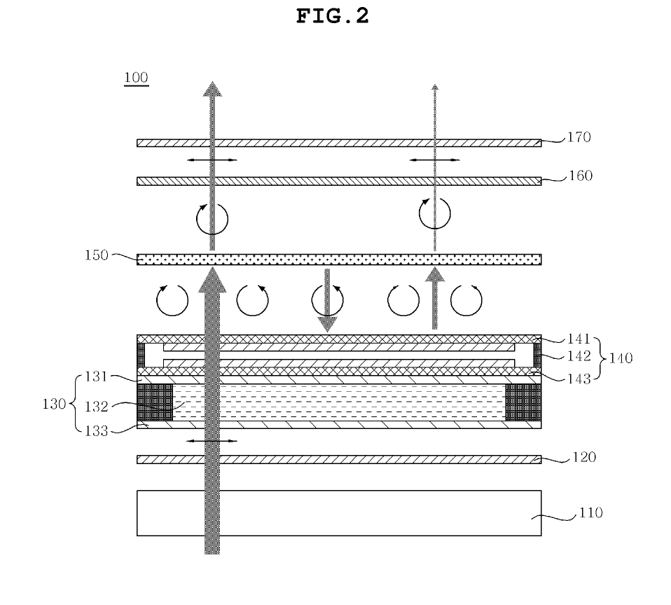

Hereinafter, the operational principle of the touch screen-integrated liquid crystal display 100 will be described with reference to FIG. 2.

The light emitted from the backlight unit 110 is converted into first polarized light while passing through the first (lower) polarizing plate 120, and the first polarized light goes into the liquid crystal panel 130. Subsequently, the first polarized light passes through a color filter, is formed into an image by operating the liquid panel 130, and then goes into the touch screen 140. Subsequently, the first polarized light formed into the image passes through the touch screen 140 and then reaches the cholesteric liquid plate 150. This polarized light includes both left circular polarized light and right circular polarized light.

In this case, the circular polarized light oriented in the same direction as the spiral direction of the cholesteric liquid crystal plate 150 is reflected, and the circular polarized light oriented in a direction different from the spiral direction thereof is allowed to pass. For example, as shown in FIG. 2, when the cholesteric liquid crystal plate 150 is twisted right, left circular polarized light passes through the cholesteric liquid crystal plate 150, and right circular polarized light is reflected by the cholesteric liquid crystal plate 150.

The circular polarized light that has passed through the cholesteric liquid crystal plate 150 is converted into linear polarized light while passing through the phase different plate 160, and the linear polarized light is discharged to the outside of the touch screen-integrated liquid crystal display 100 to transfer the image to users.

Meanwhile, the polarized light (for example, right circular polarized light) reflected from the cholesteric liquid crystal plate 150 is re-reflected by the touch screen 140 and the liquid crystal display 130 formed beneath the cholesteric liquid crystal plate 150. The re-reflected light is divided into left circular polarized light and right circular polarized light, and then goes into the cholesteric liquid crystal plate 150 again. Even in this case, the circular polarized light oriented in a direction different from the spiral direction of the cholesteric liquid crystal plate 150 is allowed to pass.

When the procedures are repeatedly conducted, the amount of the light passing through the cholesteric liquid crystal plate 150 is increased, so that the cholesteric liquid crystal plate 150 recycles light, with the result that light transmissivity is increased, thereby improving the brightness of the touch screen-integrated liquid crystal display 100.

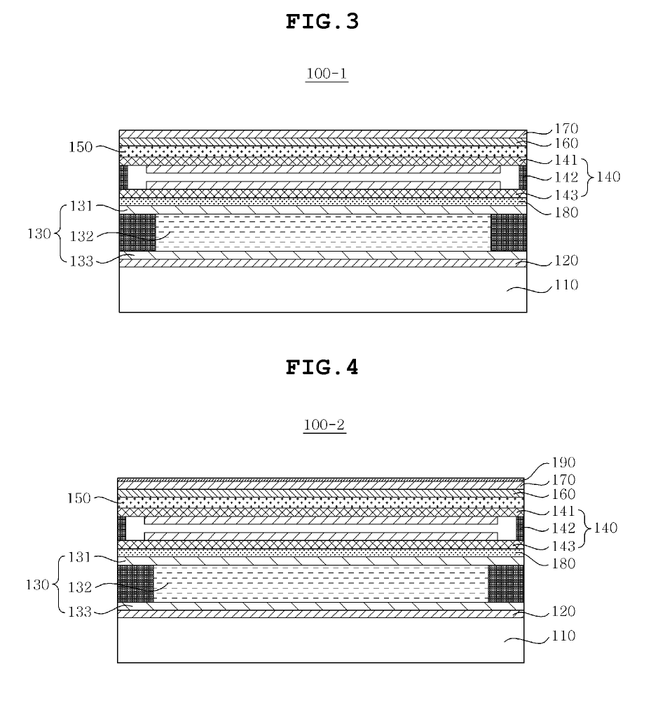

FIGS. 3 to 6 are sectional views showing touch screen-integrated liquid crystal displays according to other embodiments of the present invention. Hereinafter, the touch screen-integrated liquid crystal displays according to these embodiments will be described with reference to FIGS. 3 to 6. However, descriptions overlapping with the above description referring to FIGS. 1 and 2 will be omitted.

As shown in FIG. 3, the touch screen-integrated liquid crystal display 100-1 according to another embodiment further includes a diffusion sheet 180 disposed between the liquid crystal panel 140 and the touch screen 140.

The diffusion sheet 180 re-reflects the light from the cholesteric liquid crystal plate 150 to improve the transmissivity of the light discharged to the outside of the touch screen-integrated liquid crystal display 100-1.

Generally, even when the light reflected from the cholesteric liquid crystal plate 150 is re-reflected by the touch screen 140 and the liquid crystal panel 130, its re-reflection efficiency is decreased because it is partially absorbed by the touch screen 140 and the liquid crystal panel 130. Therefore, the diffusion sheet 180 can re-reflect most of the light reflected from the cholesteric liquid crystal plate 150.

As shown in FIG. 4, the touch screen-integrated liquid crystal display 100-2 according to still another embodiment further includes a protective film 190 on the second polarizing plate 170.

The second polarizing plate 170 may be damaged when it is exposed to the outside, thus decreasing the brightness of a touch screen-integrated liquid crystal display.

Particularly, when the touch screen 140 employed in the touch screen-integrated liquid crystal display 100-2 is a resistive touch screen, there is a problem in that the second polarizing plate 170 is frequently brought into contact with the fingers of a user.

For this reason, the transparent protective film 190 is disposed on the second polarizing plate 170, thus protecting the second polarizing plate 170 and maintaining the brightness of the touch screen-integrated liquid crystal display 100-2.

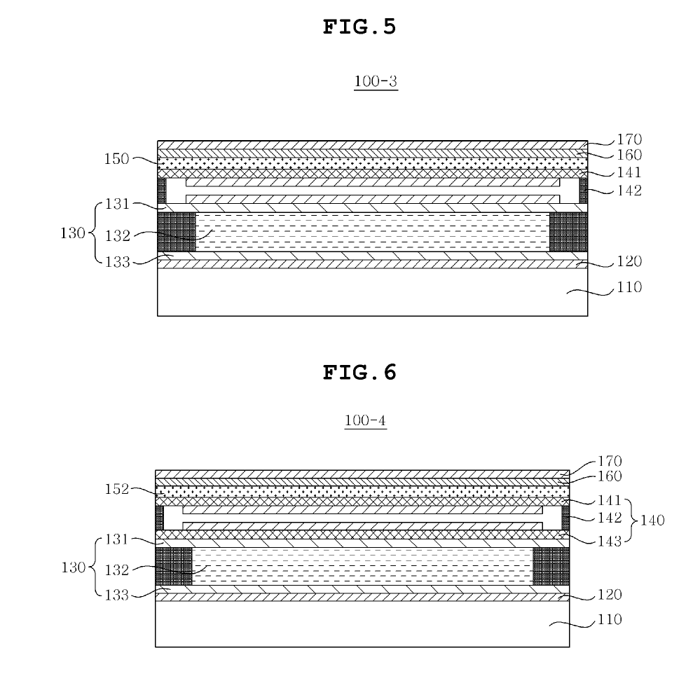

As shown in FIG. 5, the touch screen-integrated liquid crystal display 100-3 according to still another embodiment of the present invention is characterized in that the upper substrate 131 of the liquid crystal panel 130 and the lower substrate 143 of the touch screen 140 are formed into one substrate.

Therefore, the touch screen-integrated liquid crystal display 100-3 may have a slim structure. This touch screen-integrated liquid crystal display 100-3 is formed by printing the lower transparent electrode film and the lower electrode wiring of the touch screen 140 on the upper substrate 131 of the liquid crystal panel 130, with a transparent common electrode formed beneath the upper substrate 131. Therefore, the touch screen-integrated liquid crystal display 100-3, differently from the touch screen-integrated liquid crystal display 100 shown in FIG. 1, does not include the lower substrate 143 of the touch screen 140.

As shown in FIG. 5, since the touch screen-integrated liquid crystal display 100-3 has a slim structure, its light transmissivity is improved, and its manufacturing process is simplified.

As shown in FIG. 6, the touch screen-integrated liquid crystal display 100-4 according to still another embodiment of the present invention is characterized in that the cholesteric liquid crystal plate 150 is formed by coating cholesteric liquid crystal 152 between the upper plate 141 of the touch screen 140 and the phase difference plate 160.

For this reason, since the upper film substrate 151 and lower film substrate 152 of the cholesteric liquid crystal plate 150 need not be provided, the touch screen-integrated liquid crystal display 100-4 may have a slim structure, and its manufacturing process is simplified.

In the touch screen-integrated liquid crystal display shown in FIG. 1, the cholesteric liquid crystal plate 150 is formed by coating the cholesteric liquid crystal 152 between the upper film substrate 151 and the lower film substrate 153 thereof. However, in the touch screen-integrated liquid crystal display 100-4, the cholesteric liquid crystal plate 150 is formed by directly coating the upper substrate 141 of the touch screen 140 with the cholesteric liquid crystal 152 and then applying the phase difference plate thereon, not by separately forming a cholesteric liquid crystal plate and then attaching the cholesteric liquid crystal plate to the touch screen.

As described above, according to the touch screen-integrated liquid crystal display of the present invention, light transmissivity is improved because it includes a cholesteric liquid crystal plate.

Further, according to the present invention, since a cholesteric liquid crystal plate is disposed in a touch screen and is formed by coating, a process of manufacturing the liquid crystal display is simplified, and the adhesion between the cholesteric liquid crystal plate and the touch screen is increased.

Further, according to the present invention, light transmissivity is improved, so that power consumption is decreased, thereby improving portability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Simple modifications, additions and substitutions of the present invention belong to the scope of the present invention, and the specific scope of the present invention will be clearly defined by the appended claims.

What is claimed is:

1. A touch screen-integrated liquid crystal display, comprising:
a backlight unit emitting light;
a first polarizing plate disposed on the backlight unit;
a liquid crystal panel disposed on the first polarizing plate and creating an image using the light emitted from the backlight unit;
a touch screen disposed on the liquid crystal panel;
a cholesteric liquid crystal plate disposed on the touch screen;
a phase difference plate disposed on the cholesteric liquid crystal plate; and
a second polarizing plate disposed on the phase difference plate.

2. The touch screen-integrated liquid crystal display according to claim 1, further comprising: a diffusion sheet disposed between the liquid crystal panel and the touch screen.

3. The touch screen-integrated liquid crystal display according to claim 1, further comprising: a protective film disposed on the second polarizing plate.

4. The touch screen-integrated liquid crystal display according to claim 1, wherein an upper substrate of the liquid crystal panel and a lower substrate of the touch screen are formed into one substrate.

5. The touch screen-integrated liquid crystal display according to claim 1, wherein the cholesteric liquid crystal plate is formed by coating cholesteric liquid crystal between the upper substrate of the touch screen and the phase difference plate.
